(19) United States
(12) Patent Application Publication
(10) Pub. No.: US 2025/0074838 A1
(43) Pub. Date: Mar. 6, 2025

(54) INSULATING SUBSTRATE

(71) Applicant: ROHM CO., LTD., Kyoto-shi (JP)

(72) Inventor: Goro NAKATANI, Kyoto-shi (JP)

(21) Appl. No.: 18/815,482

(22) Filed: Aug. 26, 2024

(30) Foreign Application Priority Data
Sep. 1, 2023 (JP) 2023-142148

(51) Int. Cl. C04B 41/50; B41J 2/335; C04B 41/00; C04B 41/86; H01B 17/56

(52) U.S. Cl. CPC C04B 41/5022; B41J 2/33535; B41J 2/33545; B41J 2/3358; C04B 41/009; C04B 41/86; H01B 17/56

(57) ABSTRACT

An insulating substrate comprises a ceramic substrate having a major surface, a plurality of first ribs formed on the major surface, and a glaze layer disposed on the major surface so as to cover the plurality of first ribs. The plurality of first ribs in plan view extend in a first direction and are spaced in a second direction orthogonal to the first direction and thus aligned.

### CROSS REFERENCE TO RELATED APPLICATIONS

This nonprovisional application is based on Japanese Patent Application No. 2023-142148 filed on Sep. 1, 2023 with the Japan Patent Office, the entire contents of which are hereby incorporated by reference.

### BACKGROUND OF THE INVENTION

### Field of the Invention

The present disclosure relates to an insulating substrate.

### Description of the Background Art

For example, Japanese Patent Laying-Open No. 2022-078607 describes a thermal print head. The thermal print head described in Japanese Patent Laying-Open No. 2022-078607 is formed using an insulating substrate.

The insulating substrate comprises a ceramic substrate and a glaze layer. The ceramic substrate has a major surface. The glaze layer is disposed on the major surface. The glaze layer is formed by applying glass paste on the major surface and firing the applied paste.

### BRIEF DESCRIPTION OF DRAWINGS

FIG. 1 is a plan view of an insulating substrate 100.

FIG. 2 is a cross section taken along II-II indicated in FIG. 1.

FIG. 3 is a plan view of a thermal print head 200.

FIG. 4 is a cross section taken along IV-IV indicated in FIG. 3.

FIG. 5 is a cross section taken along V-V indicated in FIG. 3.

FIG. 6 is a flowchart of a process for manufacturing insulating substrate 100.

FIG. 7 is a cross section for illustrating a rib formation step S2.

FIG. 8 is a flowchart of a process for manufacturing thermal print head 200.

FIG. 9 is a cross section for illustrating an interconnect layer formation step S5.

FIG. 10 is a cross section for illustrating a heating element formation step S7.

FIG. 11 is a plan view of an insulating substrate 100A.

FIG. 12 is a cross section taken along XII-XII indicated in FIG. 11.

### DETAILED DESCRIPTION

Embodiments of the present disclosure will now be described specifically with reference to the drawings. In the figures referred to below, identical or equivalent components are identically denoted and will not be described repeatedly.

### First Embodiment

An insulating substrate according to a first embodiment will now be described. The insulating substrate according to the first embodiment is referred to as an insulating substrate 100.

<Configuration of Insulating Substrate 100>

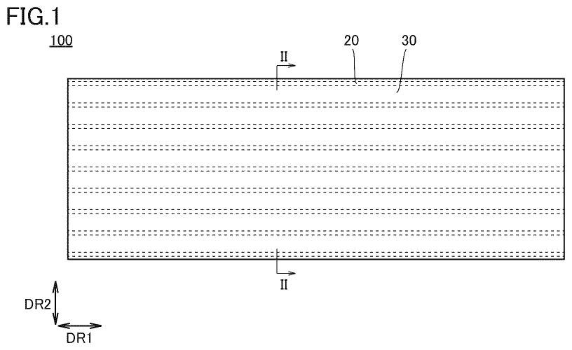

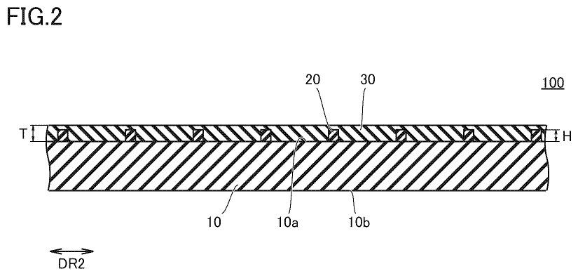

Insulating substrate 100 has a configuration, as described below. FIG. 1 is a plan view of insulating substrate 100. FIG. 2 is a cross section taken along II-II indicated in FIG. 1. As shown in FIGS. 1 and 2, insulating substrate 100 comprises a ceramic substrate 10, a plurality of ribs 20, and a glaze layer 30.

Ceramic substrate 10 has a major surface 10a and a major surface 10b. Major surfaces 10a and 10b are end surfaces in the direction of the thickness of ceramic substrate 10. Major surface 10b is a surface opposite to major surface 10a. Ceramic substrate 10 is composed of material for example with alumina (Al₂O₃) or a similar ceramic material as a major component. A major component refers to a component that accounts for more than 50 percent of the material.

Rib 20 is formed on major surface 10a. Rib 20 extends in a first direction DR1 in plan view. Plan view refers to a view on the side of major surface 10a in a direction normal to major surface 10a. The plurality of ribs 20 in plan view are spaced in a second direction DR2 and thus aligned. Second direction DR2 is a direction orthogonal to first direction DR1. Any two adjacent ribs 20 are equally spaced for example. Any two adjacent ribs 20 are spaced for example by 20 mm or less. A lower limit for the spacing between any two adjacent ribs 20 is not particularly limited insofar as the two ribs 20 can be spaced and thus formed. In second direction DR2, rib 20 has a width for example of 500 μm or less. A lower limit value for the width of rib 20 in second direction DR2 is not particularly limited insofar as rib 20 can be formed.

Rib 20 has a height H. Rib 20 is composed of material with a ceramic material as a major component, for example. Rib 20 is formed for example of a sintered compact including a plurality of grains. The grains included in the sintered compact constituting rib 20 are ceramic grains. The ceramic grains included in the sintered compact may be composed of material identical to or different from that of ceramic substrate 10. The plurality of grains included in the sintered compact have an average grain size for example of 1 μm or less. The average grain size of the plurality of grains included in the sintered compact is measured for example through laser diffraction/scattering.

Glaze layer 30 is disposed on major surface 10a so as to cover the plurality of ribs 20. Glaze layer 30 is composed of material with glass as a major component. Glaze layer 30 has a thickness T. Thickness T is a distance between major surface 10a and a surface of glaze layer 30. Height H is preferably equal to or larger than 0.7 times and less than 1.0 times thickness T. Thickness T is preferably 100 μm or more, 150 μm or more, or 200 μm or more. Thickness T is, for example, 300 μm or less.

### <Configuration of Thermal Print Head 200>

Hereinafter, a configuration of a thermal print head 200 will be described.

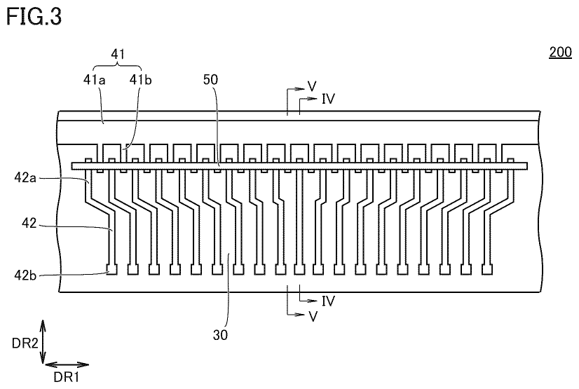

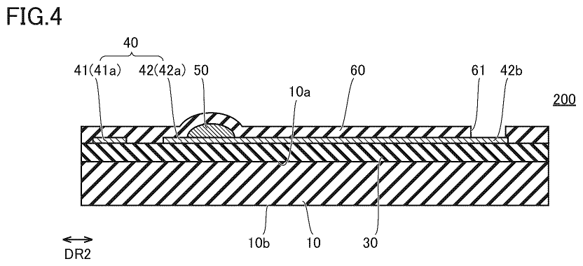

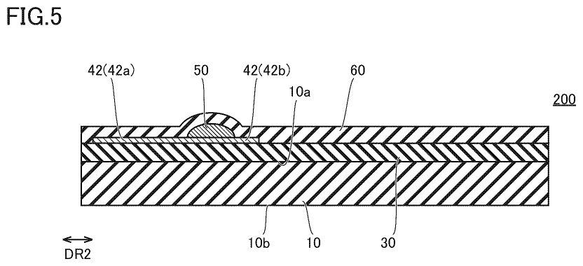

A thermal print head formed using insulating substrate 100 is referred to as thermal print head 200. FIG. 3 is a plan view of thermal print head 200. Note that FIG. 3 does not show a protective layer 60. FIG. 4 is a cross section taken along IV-IV indicated in FIG. 3. FIG. 5 is a cross section taken along V-V indicated in FIG. 3. As shown in FIGS. 3 to 5, thermal print head 200 comprises insulating substrate 100, an interconnect layer 40, a heating element 50, and protective layer 60.

Interconnect layer 40 is disposed on glaze layer 30. Interconnect layer 40 includes a common electrode 41 and a plurality of individual electrodes 42. Interconnect layer 40 is composed of material with gold (Au) as a major component for example.

Common electrode 41 has a strip portion 41a and a plurality of projecting portions 41b. Strip portion 41a extends in first direction DR1 in plan view. The plurality of projecting portions 41b are spaced in first direction DR1 and thus aligned. Projecting portion 41b projects from strip portion 41a in second direction DR2. Individual electrode 42 has one end with a tip portion 42a. Tip portion 42a extends in second direction DR2 in plan view. Projecting portion 41b and tip portion 42a are aligned alternately in first direction DR1. Individual electrode 42 has the other end with a bonding pad 42b.

Although not shown, thermal print head 200 further comprises a first interconnect and a second interconnect. The first interconnect is mainly disposed on glaze layer 30 and is electrically connected to common electrode 41. The second interconnect is disposed on the first interconnect. The first and second interconnects are formed for example of a sintered compact including silver (Ag) grains.

Heating element 50 extends in first direction DR1 in plan view. Heating element 50 is disposed on glaze layer 30 while overlapping projecting portion 41b and tip portion 42a. Heating element 50 is composed for example of glass and conductive grains contained in the glass. The conductive grains are formed for example of ruthenium oxide (RuO₂). Any adjacent projecting portion 41b and tip portion 42a are electrically interconnected by heating element 50.

Protective layer 60 is disposed on glaze layer 30 so as to cover interconnect layer 40, the first and second interconnects, and heating element 50. Protective layer 60 has an opening 61. Opening 61 exposes bonding pad 42b. Protective layer 60 is composed of material for example with glass as a major component.

A fixed potential is applied to common electrode 41. A potential is selectively applied to each of the plurality of individual electrodes 42 from a driver IC. Thus, heating element 50 interconnecting tip portion 42a of one individual electrode 42 to which a potential is selectively applied and projecting portion 41b adjacent to tip portion 42a of that one individual electrode 42 is energized and thus generates heat. The heat is transferred to a sheet of paper to print thereon.

### <Method for Manufacturing Insulating Substrate 100>

Hereinafter, a method for manufacturing insulating substrate 100 will be described.

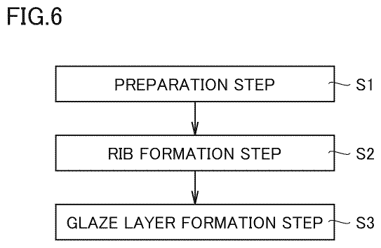

FIG. 6 is a flowchart of a process for manufacturing insulating substrate 100. As shown in FIG. 6, the method for manufacturing insulating substrate 100 comprises a preparation step S1, a rib formation step S2, and a glaze layer formation step S3. Rib formation step S2 is performed after preparation step S1. Glaze layer formation step S3 is performed after rib formation step S2.

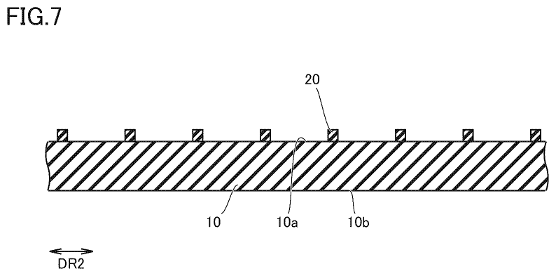

In preparation step S1, ceramic substrate 10 is prepared. FIG. 7 is a cross section for illustrating rib formation step S2. As shown in FIG. 7, in rib formation step S2, rib 20 is formed. In rib formation step S2, first, a paste including grains to configure rib 20 is applied on major surface 10a and dried. Preferably, the steps of applying and drying the paste are repeated a plurality of times. Second, the paste disposed on major surface 10a is fired. Rib 20 is thus formed. Note that height H is increased by repeating the steps of applying and drying the paste a plurality of times. The paste may be applied by printing or with a dispenser.

In glaze layer formation step S3, glaze layer 30 is formed. Glaze layer 30 is formed by applying a glass-containing paste on major surface 10a so as to cover rib 20 and firing the applied paste. Insulating substrate 100 having the structure shown in FIGS. 1 and 2 is thus formed.

### <Method for Manufacturing Thermal Print Head 200>

Hereinafter, a method for manufacturing thermal print head 200 will be described.

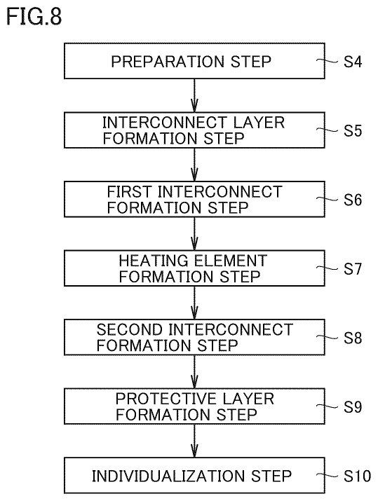

FIG. 8 is a flowchart of a process for manufacturing thermal print head 200. As shown in FIG. 8, the method for manufacturing thermal print head 200 comprises a preparation step S4, an interconnect layer formation step S5, a first interconnect formation step S6, a heating element formation step S7, a second interconnect formation step S8, a protective layer formation step S9, and an individualization step S10. Interconnect layer formation step S5 is performed after preparation step S4. First interconnect formation step S6 is performed after interconnect layer formation step S5. Heating element formation step S7 is performed after first interconnect formation step S6. Second interconnect formation step S8 is performed after heating element formation step S7. Protective layer formation step S9 is performed after second interconnect formation step S8. Individualization step S10 is performed after protective layer formation step S9.

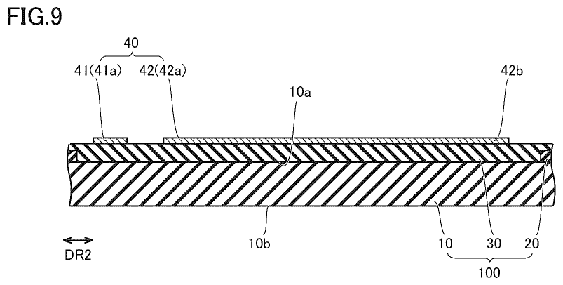

In preparation step S4, insulating substrate 100 is prepared. FIG. 9 is a cross section for illustrating interconnect layer formation step S5. As shown in FIG. 9, in interconnect layer formation step S5, interconnect layer 40 is formed. In interconnect layer formation step S5, first, a resinate paste including the material for interconnect layer 40 is applied on glaze layer 30. Second, the applied resinate paste is fired to form a metal layer. Third, a resist pattern is formed on the metal layer. The resist pattern is formed by applying a photoresist on the metal layer and exposing and developing the applied photoresist. Fourth, the metal layer is etched while the resist pattern is used as a mask. The metal layer is thus patterned to be interconnect layer 40.

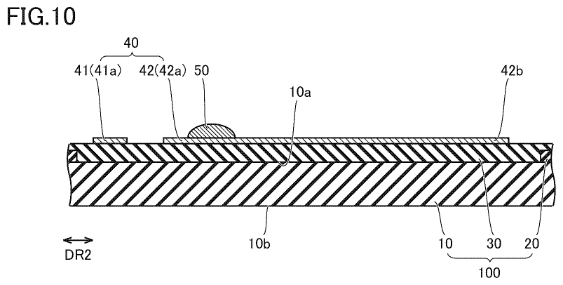

In first interconnect formation step S6, a first interconnect is formed. The first interconnect is formed by applying a conductive paste including a plurality of silver grains, and firing the applied conductive paste. FIG. 10 is a cross section for illustrating heating element formation step S7. As shown in FIG. 10, in heating element formation step S7, heating element 50 is formed. In heating element formation step S7, first, a conductive paste including glass and ruthenium oxide grains is applied. Second, the applied conductive paste is fired to be heating element 50.

In second interconnect formation step S8, a second interconnect is formed. The second interconnect is formed by applying a conductive paste including a plurality of silver grains, and firing the applied conductive paste. In protective layer formation step S9, protective layer 60 is formed. Protective layer 60 is formed by applying a glass-containing paste and firing the applied paste. In individualization step S10, insulating substrate 100 is cut along a boundary for thermal print head 200 for example by irradiation with laser light. A plurality of thermal print heads 200 having the structure shown in FIGS. 3 to 5 are thus obtained.

### <Effect of Insulating Substrate 100>

Insulating substrate 100 has an effect, as described below.

Glaze layer 30 is formed by applying a glass-containing paste on major surface 10a and firing the applied glass. The applied paste is easily dried on a peripheral edge of major surface 10a, and the paste around the peripheral edge flows toward the peripheral edge. As a result, glaze layer 30 is raised on the peripheral edge of major surface 10a, that is, the coffee ring effect is caused. Glaze layer 30 is raised more significantly as thickness T increases. For example, when glaze layer 30 having thickness T of 200 μm is formed, and rib 20 is absent, glaze layer 30 may be raised on the peripheral edge of major surface 10a to a height exceeding 50 μm. It is difficult to form thermal print head 200 at the raised portion of glaze layer 30, resulting in a reduced number of thermal print heads 200 obtained from a single insulating substrate 100.

In this regard, insulating substrate 100 having rib 20 formed on major surface 10a allows rib 20 to partition the paste applied on major surface 10a and thus reduce a volume of the paste contributing to the coffee ring effect. As a result, insulating substrate 100 can suppress raising of glaze layer 30 on the peripheral edge of major surface 10a and hence increase the number of thermal print heads 200 obtained from a single insulating substrate 100.

If height H is excessively smaller than thickness T, the applied paste may flow beyond rib 20. Accordingly, height H set to be equal to or larger than 0.7 times and less than 1.0 times thickness T can more reliably suppress raising of glaze layer 30. When rib 20 is composed of a sintered compact including a plurality of grains, height H can be easily adjusted by repeating applying and drying a paste including such grains. Further, when such grains have an average grain size of 1.0 μm or less, rib 20 can be formed to have a shape with high precision.

### Second Embodiment

An insulating substrate according to a second embodiment will now be described. The insulating substrate according to the second embodiment is referred to as an insulating substrate 100A. Hereinafter, to avoid repeating redundant description, a point different than insulating substrate 100 will mainly be described.

### <Configuration of Insulating Substrate 100A>

A configuration of insulating substrate 100A will be described below.

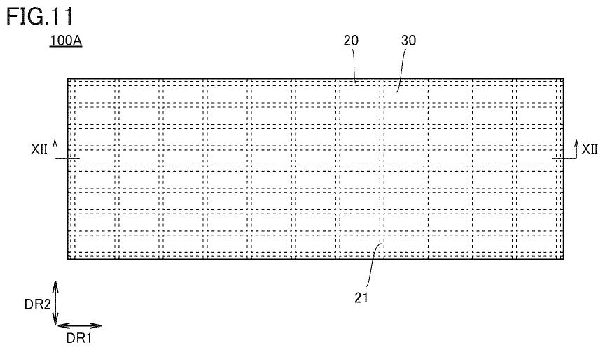

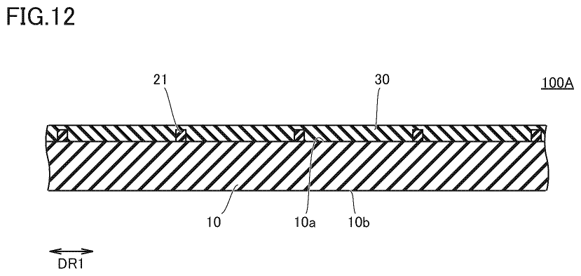

FIG. 11 is a plan view of insulating substrate 100A. FIG. 12 is a cross section taken along XII-XII indicated in FIG. 11. As shown in FIGS. 11 and 12, insulating substrate 100A comprises ceramic substrate 10, rib 20, and glaze layer 30. In this regard, the configuration of insulating substrate 100A is identical to the configuration of insulating substrate 100.

Insulating substrate 100A further comprises a plurality of ribs 21. In this regard, the configuration of insulating substrate 100A is different from the configuration of insulating substrate 100. Rib 21 extends in second direction DR2 in plan view. That is, rib 21 intersects rib 20 in plan view. The plurality of ribs 21 in plan view are spaced in first direction DR1 and thus aligned. The configuration of rib 21 is similar to the configuration of rib 20 except for the direction in which rib 21 extends in plan view and that in which ribs 21 are aligned in plan view. Any two adjacent ribs 21 are spaced for example by 20 mm or less. A lower limit for the spacing between any two adjacent ribs 21 is not particularly limited insofar as the two ribs 21 can be spaced and thus formed. In first direction DR1, rib 21 has a width for example of 500 μm or less. A lower limit value for the width of rib 21 in first direction DR1 is not particularly limited insofar as rib 21 can be formed.

### <Method for Manufacturing Insulating Substrate 100A>

Hereinafter, a method for manufacturing insulating substrate 100A will be described.

The method for manufacturing insulating substrate 100A is the same as the method for manufacturing insulating substrate 100 in that the method comprises preparation step S1, rib formation step S2, and glaze layer formation step S3. The method for manufacturing insulating substrate 100A is different from the method for manufacturing insulating substrate 100 in that rib 21 is also formed as well as rib 20 in rib formation step S2.

### <Effect of Insulating Substrate 100A>

Hereinafter, an effect of insulating substrate 100A will be described.

Insulating substrate 100A has major surface 10a with rib 20 and, in addition, rib 21 formed thereon. Therefore, insulating substrate 100A can suppress not only flowing of paste in second direction DR2 but also flowing of paste in first direction DR1, and can further suppress raising of glaze layer 30 on a peripheral edge of major surface 10a.

### Additional Notes

An embodiment of the present disclosure comprises the following configurations:

### <Additional Note 1>

An insulating substrate comprising:
a ceramic substrate having a major surface;
a plurality of first ribs formed on the major surface; and
a glaze layer disposed on the major surface so as to cover the plurality of first ribs,
in plan view, the plurality of first ribs extending in a first direction and spaced in a second direction and thus aligned, the second direction being orthogonal to the first direction.

### <Additional Note 2>

The insulating substrate according to Additional Note 1, wherein the glaze layer has a thickness equal to or larger than 0.7 times and less than 1.0 times a height of each of the plurality of first ribs.

### <Additional Note 3>

The insulating substrate according to Additional Note 1 or 2, wherein the glaze layer has a thickness of 100 μm or more.

### <Additional Note 4>

The insulating substrate according to any one of Additional Notes 1 to 3, further comprising a plurality of second ribs formed on the major surface, wherein
in plan view, the plurality of second ribs extend in the second direction and are spaced in the first direction and thus aligned, and
the glaze layer further covers the plurality of second ribs.

### <Additional Note 5>

The insulating substrate according to any one of Additional Notes 1 to 4, wherein the plurality of first ribs are each composed of material that is a sintered compact including a plurality of grains.

### <Additional Note 6>

The insulating substrate according to Additional Note 5, wherein the plurality of grains have an average grain size of 1.0 μm or less.

While the present invention has been described in embodiments, it should be understood that the embodiments disclosed herein are illustrative and non-restrictive in any respect. The scope of the present invention is defined by the terms of the claims, and is intended to include any modifications within the meaning and scope equivalent to the terms of the claims.

What is claimed is:

1. An insulating substrate comprising:
a ceramic substrate having a major surface;
a plurality of first ribs formed on the major surface; and
a glaze layer disposed on the major surface so as to cover the plurality of first ribs,
in plan view, the plurality of first ribs extending in a first direction and spaced in a second direction and thus aligned, the second direction being orthogonal to the first direction.

2. The insulating substrate according to claim 1, wherein the glaze layer has a thickness equal to or larger than 0.7 times and less than 1.0 times a height of each of the plurality of first ribs.

3. The insulating substrate according to claim 1, wherein the glaze layer has a thickness of 100 μm or more.

4. The insulating substrate according to claim 1, further comprising a plurality of second ribs formed on the major surface, wherein
in plan view, the plurality of second ribs extend in the second direction and are spaced in the first direction and thus aligned, and
the glaze layer further covers the plurality of second ribs.

5. The insulating substrate according to claim 1, wherein the plurality of first ribs are each composed of material that is a sintered compact including a plurality of grains.

6. The insulating substrate according to claim 5, wherein the plurality of grains have an average grain size of 1.0 μm or less.
